(19) United States
(12) Patent Application Publication
(10) Pub. No.: US 2026/0332288 A1
(43) Pub. Date: Oct. 22, 2026

(54) LINK ADAPTATION FOR RE-TRANSMISSION OF A TRANSPORT BLOCK BASED ON A TARGET BLOCK ERROR PROBABILITY (BLEP)

(71) Applicant: Telefonaktiebolaget LM Ericsson (publ), Stockholm (SE)

(72) Inventors: Jonas FRÖBERG OLSSON, LJUNGSBORO (SE); Alexey SHAPIN, Linköping (SE)

(73) Assignee: Telefonaktiebolaget LM Ericsson (publ), Stockholm (SE)

(21) Appl. No.: 19/106,706

(22) PCT Filed: Aug. 14, 2023
(86) PCT No.: PCT/SE2023/050819

§ 371 Date: Feb. 26, 2025

Related U.S. Application Data
(60) Provisional application No. 63/411,917, filed on Sep. 30, 2022.

(51) Int. Cl. H04L 1/00; H04L 1/08

(52) U.S. Cl. CPC H04L 1/0003; H04L 1/08

(57) ABSTRACT

The present disclosure provides a method in a network node. The method includes: obtaining an accumulated number of transmitted bits from previous transmissions of a transport block and quality measures for the previous transmissions of the transport block. Then the network node estimates a block error probability (BLEP) for the re-transmission of the transport block based on using a selected modulation, and compares the estimated BLEP with a target BLEP. In response to the estimated BLEP being less than the target BLEP, the network node re-transmits the transport block using the selected modulation.

### TECHNICAL FIELD

The present disclosure relates, in general, to wireless communications and, more particularly, method and apparatus for link adaptation for re-transmission by a network node.

### BACKGROUND

In a New Radio (NR) communication system, the scheduler in a gNB is responsible for resource allocation for user equipment (UEs) in connected mode in both the uplink (UL) and the downlink (DL). FIG. 1 illustrates how a scheduler 120 in a network 100 interacts with the QoS unit 110 in the core network and a link adaptation function 130, which may reside in a gNB. In particular, as shown in FIG. 1, the scheduler 120 receives, from a QoS unit 110 in the core network, an input related to the required quality of service (QoS) for each UE/service handled by the gNB. The scheduler 120 works closely with a link adaptation (LA) function 130 to select a proper transport block format for uplink and downlink transmissions to/from the UE 150. The LA function 130 decides the proper radio resource assignment for the UE 150 based on estimated signal to interference plus noise ratio (SINR), the outcome of the UE's previous transmission (ACK/NACK), the UE's power headroom, and the available bandwidth.

The network transmits the resource assignments determined by the scheduler 120 to the UE 150. A power control function 140 in the network controls the transmission power of the UE 150 via a transmission power control (TPC) command. The UE 150 provides channel feedback to the network in the form of channel state information (CSI).

The scheduler 120 and the link adaptation function 130 in a gNB have the task of selecting a transport format consisting of a resource allocation, number of layers, and modulation and coding scheme for a downlink transmission based on reported CSI from the UE. For uplink transmissions, the selection is based on CSI measured by the gNB. For services with high reliability requirements this can be a challenging task, especially if the transport format also should be spectrally efficient. Since the transmission for which link adaption is performed occurs later than when the CSI was measured, the scheduler 120 and link adaptation function 130 have to predict the SINR at transmission based on an “observed” SINR that can be determined from reported or measured CSI. One such prediction typically used is that predicted SINR is equal to the last “reported/measured” SINR.

A fundamental problem with link adaption is that in general it is difficult for the gNB to accurately predict the SINR that a future transmission will experience. That is, there is an associated uncertainty to any predicted SINR. Traditional link adaptation mitigates the uncertainty by relying on hybrid automatic repeat request (HARQ) re-transmissions. However, for services with latency requirements, the number of HARQ re-transmissions that can be performed may be limited, which means that the uncertainty may need to be accounted for in the link adaptation.

The uncertainty in the predicted SINR may depend on several factors, including:
Age of CSI report
CSI report quantization
CQI to SINR mapping error
Channel variations, e.g. fading and mobility
Intercell/Intracell Interference variation
Measurement error, e.g. SRS, CSI-RS/IM measurement errors

To account for the uncertainty in predicted SINR, one common approach is to select a backoff to the “predicted” SINR (in the logarithm domain) to make the SINR prediction more conservative:

SINR_{used-prediction}=SINR_{predicted}−backoff [1]

where SINR_{used-prediction} is the SINR used as a prediction and SINR_{predicted} is the “predicted” SINR that often is the same as the last “observed” SINR. In some cases, the SINR_{predicted} may be determined in a way that accounts for one or more of the factors that contributes to the uncertainty. In such cases, the remaining uncertainty may be reduced, and the backoff can therefore also be reduced.

In a typical link adaptation process, a modulation and coding scheme (MCS) value is selected for a transmission such that the Block-Error Probability (BLEP) does not exceed 10% assuming that the actual SINR of the transmission is equal to SINR_{used-prediction}.

HARQ re-transmissions are also an efficient method to mitigate uncertainty in predicted SINR. When link adaption is performed for a re-transmission, the transport block size is the same as for the initial transmissions. However, the transmission parameters for re-transmission, such as number of layers, resource allocation size, redundancy version, and modulation, can differ from the initial transmission. The number of layers, resource allocation size and modulation determine the number of coded bits that can be transmitted, and the redundancy version determines which coded bits that are transmitted in a so-called rate-matching procedure. If the number of coded bits for initial transmission is n₀ and nᵢ is the number of coded bits transmitted for the i-th re-transmission, then the effective code rate crᵢ for the i-th re-transmission is given as:

$${cr}_{i} = \frac{{n}_{info}}{{\sum }_{j = 0}^{i} {n}_{j}} , \qquad [ 2 ]$$

where n_{info} is the number of information bits transmitted. The number of information bits is equal to the transport block size in bits plus the number of Cyclic Redundancy Check (CRC) bits. In NR, the details for determining code rate are more complicated than shown above due to the fact that the base graph for the low density parity check (LDPC) coding used for the physical uplink shared channel (PUSCH) and physical downlink shared channel (PDSCH) depends on the transport block size and the initial code rate (excluding CRC), and the fact that if the transport block size is large enough, it is split into several pieces and separately coded into several code blocks each with an attached code block CRC. For the description herein it is enough to consider the simplistic approach, since it is tedious but straightforward to adapt the description with the precise details.

### SUMMARY

It is an object of the present disclosure to provide network node, user equipment, a core network node, and methods therein, capable of more efficient way for link adaptation for re-transmission of transport blocks.

According to a first aspect of the present disclosure, a method in a network node is provided. The method includes obtaining an accumulated number of transmitted bits from previous transmission(s) of a transport block and quality measures for the previous transmission(s) of the transport block. Then the network node estimates a block error probability (BLEP) for the re-transmission of the transport block based on using a selected modulation for the re-transmission of the transport block, and compares the estimated BLEP with a target BLEP. In response to the estimated BLEP being less than the target BLEP, the network node re-transmits the transport block using the selected modulation.

In an embodiment, the method may further include, in response to the estimated BLEP being less than the target BLEP: selecting a second modulation having a lower number of bits per symbol than the selected modulation used in the previous estimation, and estimating the BLEP for the re-transmission of the transport block based on using the second modulation for the re-transmission of the transport block. Then, the network node compares the estimated BLEP based on the second modulation is less than the target BLEP. And, in response to the estimated BLEP based on the second modulation being less than the target BLEP, the network node selects the second modulation for re-transmitting.

In an embodiment, under the circumstance that no estimated BLEP based on any selected modulation is less than the target BLEP, larger resource allocation would be asked for the re-transmission.

According to a second aspect of the present disclosure, a network node is provided. The network node includes a processing circuitry and a memory. The memory contains instructions executable by the processing circuitry whereby the network node is operative to perform the method according to the first aspect.

### BRIEF DESCRIPTION OF THE DRAWINGS

The above and other objects, features and advantages will be more apparent from the following description of embodiments with reference to the figures, in which:

FIG. 1 illustrates a scheduler in a network interacts with the QoS unit in the core network and a link adaptation function residing in a gNB.

FIG. 2 illustrates operations of a gNB according to some embodiments for performing link adaptation for re-transmission of a transport block.

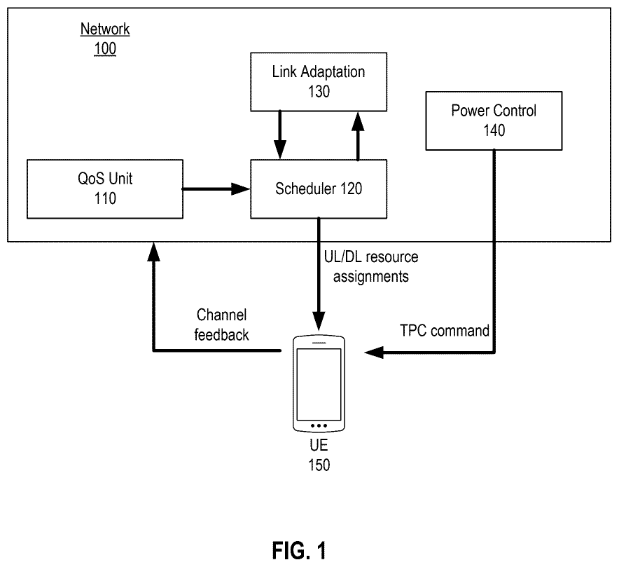

Figure QQ1 shows an example of a communication system in accordance with some embodiments.

Figure QQ2 shows an example of a UE QQ200 in accordance with some embodiments.

Figure QQ3 shows an example of a network node QQ300 in accordance with some embodiments.

Figure QQ4 is a block diagram of a host QQ400, which corresponds to an embodiment of the host of Figure QQ1, in accordance with various aspects.

Figure QQ5 is a block diagram illustrating a virtualization environment in which functions implemented by some embodiments may be virtualized.

Figure QQ6 shows a communication diagram of a host communicating via a network node with a UE over a partially wireless connection in accordance with some embodiments.

### DETAILED DESCRIPTION

There currently exist certain challenge(s). When performing LA, a coding model of the UE's decoding capability is often used. The coding model can be used in link adaptation to determine if the code rate is low enough to reach a certain BLEP given a certain SINR. The coding model can be viewed as a function, blep(n_{info}, crᵢₙᵢₜᵢₐₗ, cr_{effective}, rbir), that returns a BLEP value as a function of the number of information bits n_{info}, the initial code rate crᵢₙᵢₜᵢₐₗ, the effective code rate cr_{effective} and a value rbir that is the effective received bit information rate (RBIR), given as follows:

$$rbir = \frac{{\sum }_{j = 0}^{i} {rbi}_{j}}{{\sum }_{j = 0}^{i} {n}_{j}} . \qquad [ 3 ]$$

The quantity rbiᵢ is the received bit information for transmission i (i=0: initial transmission, i: i-th re-transmission) which is an information theoretical value that depends on the SINR, allocation size and the modulation.

When performing LA for an upcoming DL transmission i, the rbᵢ, is often determined directly from the latest CSI report. For i>0 (re-transmissions), the true rbiⱼ for j=0,1, . . . ,i−1 that prevailed in previous transmissions is not known by the gNB. The gNB knows from HARQ-ACK reporting that a previous transmission failed to be correctly decoded, but does not know what the true quality was. Therefore, LA is often performed the same way as for initial transmission, but with the constraint that the determined transport block size shall be same as for the initial transmission. The problem with performing re-transmission LA in such a way is that UE may be allocated more resources than are actually needed to correctly decode the transport block.

Certain aspects of the disclosure and their embodiments may provide solutions to these or other challenges. In particular, some embodiments provide a method performed by a gNB of a wireless communication network when performing link adaptation for an upcoming re-transmission of a transport block (TB) to a UE. The gNB obtains accumulated transmitted coded bits and quality measures for previous transmissions of the TB, and obtains a number of coded bits to be used to re-transmit the TB based on resources to be assigned for the re-transmission for a possible modulation. The gNB determines if the modulation can be used to re-transmit the TB based on at least the obtained accumulated coded bits and obtained quality measures for previous transmissions of the TB.

Some embodiments are described herein with reference to DL transmissions from the network to a UE. However, it will be appreciated that the methods described herein can be applied for UL transmissions as well. The main difference between DL and UL is that the quality of a PUSCH transmission on the UL can be directly measured by the gNB, while for DL there is currently no mechanism for the gNB to know the quality of a PDSCH transmission other than that it failed.

Certain embodiments may provide one or more of the following technical advantage(s). In particular, some embodiments may reduce resource consumption by a gNB or UE, improve spectral efficiency, reduce interference, and/or improve throughput of the system.

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

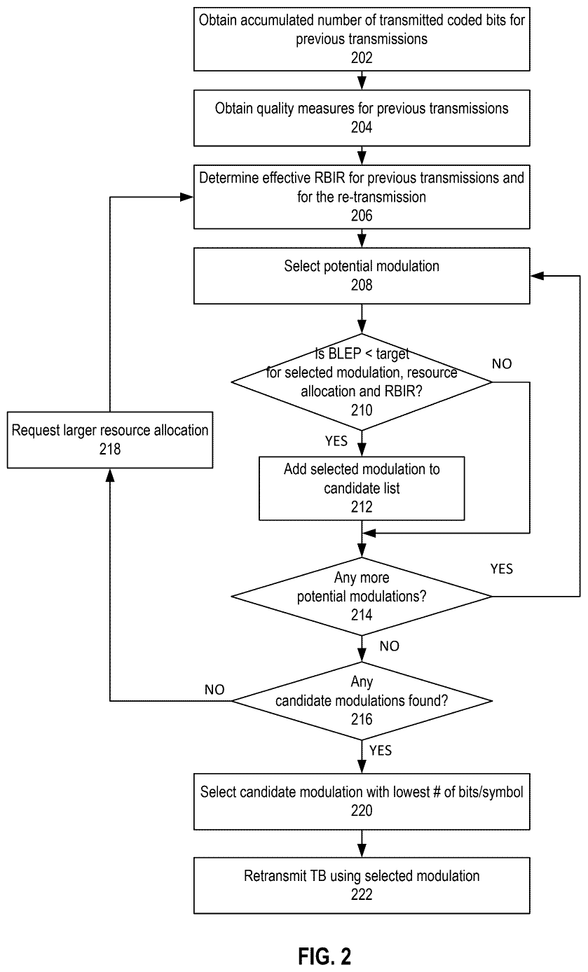

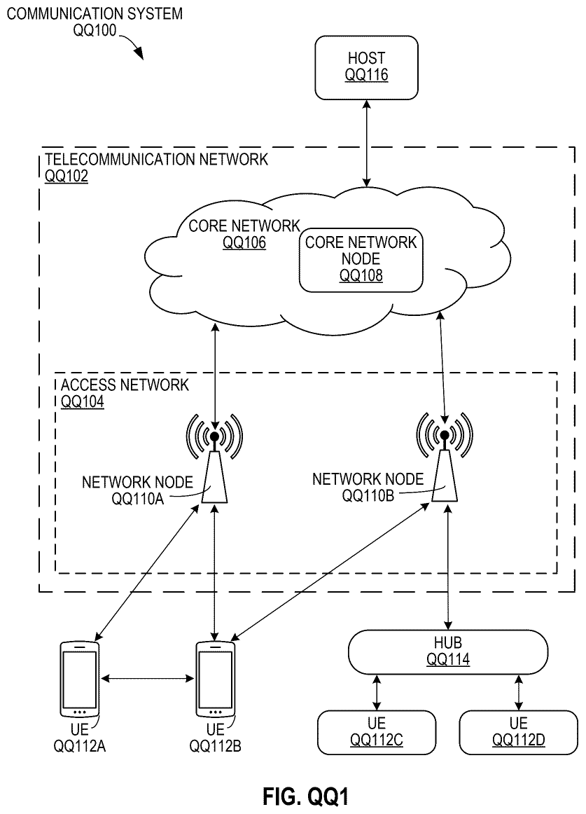

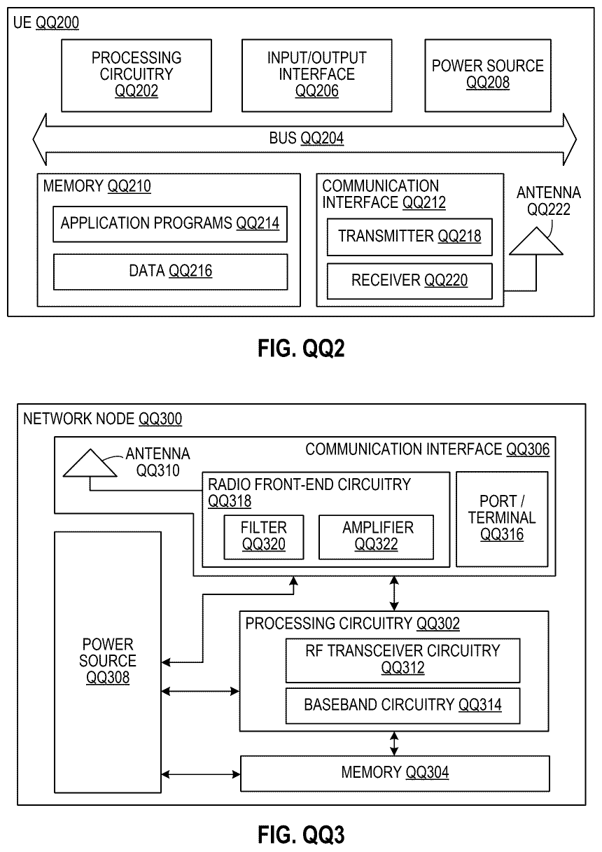

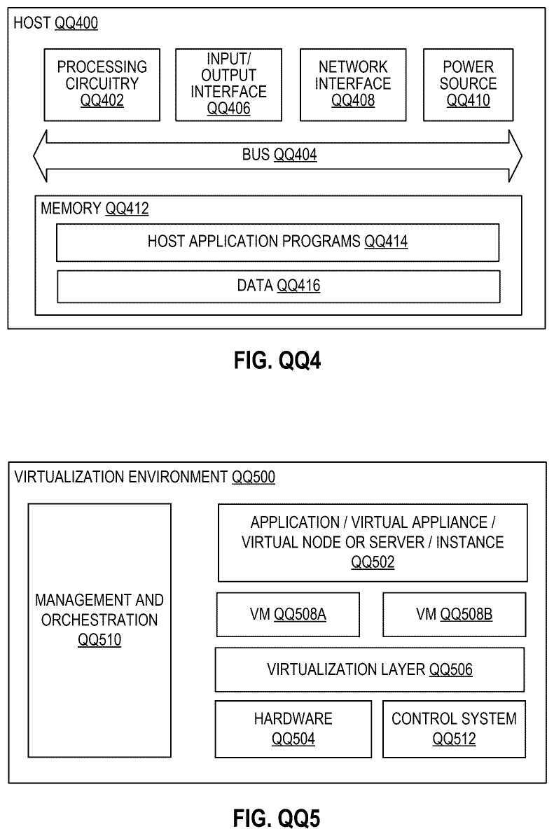

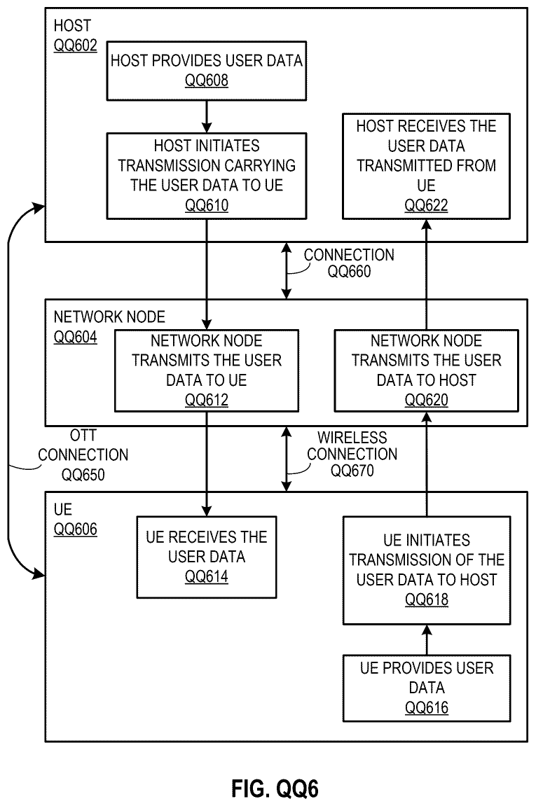

FIG. 2 illustrates operations of a gNB according to some embodiments for performing link adaptation for re-transmission of a transport block. As shown in FIG. 2, the gNB obtains an accumulated number of transmitted coded bits from previous transmissions of the transport block (block 202) and obtains quality measures for the previous transmissions of the transport block (block 204). Using this information, the gNB determines an effective RBIR for the previous transmissions and re-transmission (block 206) of the transport block.

The gNB then iterates through a list of potential modulations that can be used for the re-transmission and determines if any of the potential modulations are candidates for the re-transmission. At block 208, the gNB selects a potential modulation for the re-transmission. At block 210, the gNB calculates a BLEP that is expected to be achieved using the selected potential modulation based on the effective RBIR determined in block 206 and a resource allocation provided by the scheduler. If the BLEP predicted for the re-transmission is less than a target BLEP, the selected potential modulation is added to a list of candidate modulations at block 212 for further consideration, and operations proceed to block 214. If the BLEP is not less than the target BLEP, the selected potential modulation is not added to the list of candidate modulations.

At block 214, the gNB determines if there are any further potential modulations to consider. If so, operations return to block 208 and another potential modulation is selected. Otherwise, operations proceed to block 216, wherein the gNB determines if the foregoing process identified any candidate modulations (i.e., the gNB determines if there were any modulations for which the BLEP is less than the target BLEP given the resource allocation and the effective RBIR).

If no candidate modulations were found, the gNB requests the scheduler to provide a larger resource allocation (block 218), and the process is repeated.

If one or more candidate modulations were found, the gNB selects a candidate modulation for use in the re-transmission (block 220). In selecting a candidate modulation for use in the re-transmission, the gNB may consider the bits per symbol of the modulation. For example, the gNB may select the modulation that uses the smallest number of bits per symbol.

The gNB then re-transmits the TB using the selected modulation (block 222).

At block 202, the accumulated coded bits can be obtained from a storage wherein the number of coded bits used is stored each time a transmission is performed. The number of coded bits can be explicitly stored or can be stored implicitly. One example of implicit storage is to store the modulation used and the number of modulation symbols used in the transmission.

At block 204, the UE may report an indicator that indicates a quality measure of the PDSCH used to transmit the transport block. The indicator may for example be a CQI value reported by the UE. From the reported indicator, a SINR or RBI value can be determined by the gNB using a coding model.

In another example, the UE may not report a quality measure other than a HARQ-ACK/NACK indicating whether or not the TB was correctly received. In that case, an estimate of the channel quality may be obtained using one or more of the following methods.

For example, the channel quality may be estimated using a fixed quality measure, e.g. SINR=X dB, where X can be selected based on, e.g., the radio environment, load in the cell, etc.

In another example, the channel quality may be estimated using a value relative to the quality predicted when LA was performed. For example, if SINR was predicted as SINR=Y dB at initial transmission, then the obtained quality measure for the initial transmission can be Y−B dB where B is a fixed backoff value. The backoff value B can be function of the transmissions that have been performed. For example, if the predicted SINR was Y for each of the transmissions 0, 1, . . . , i−1, then when LA is performed for the i-th (re-)transmission, then the obtained quality measures for the transmissions 0, 1 . . . , i−1 can be determined as Y−B₀, Y−B₁, . . . , Y−B₍ᵢ₋₁₎, where the Bⱼ are fixed values.

In another example, the channel quality may be estimated using a value that is a function of the predicted quality and of an uncertainty value of the predicted quality when LA was performed. For example, the predicted quality and uncertainty value is an expected SINR mⱼ and a standard deviation sⱼ of the expected SINR for transmission j. In that case, the obtained quality values may be B₀, B₁, . . . , B_(i−1), where Bⱼ is a percentile value for a normally distributed random variable having mean mⱼ and standard deviation sⱼ. In some examples, Bⱼ can be the aⱼ percentile value. In some examples, the percentile is the same percentile for all j=0,1, . . . ,i−1, but the percentile depends on i. For example, if i=1 then B₀ could be the 25-th percentile value while if i=2 then B₀=B₁ could be the 10-th percentile value.

There are several other ways in which the Bⱼ could be obtained. For example, one other way is that Bⱼ=E{Xⱼ|Xⱼ<Aⱼ} where Xⱼ is a normally distributed random variable having mean mⱼ and standard deviation sⱼ, E{·} denotes the expected value Xⱼ conditioned that it is lower than a threshold Aⱼ. The value Aⱼ can be determined as the SINR value for which the error probability of transmitting the TB would exceed a threshold, e.g. 25%.

In some embodiments, the method for obtaining quality estimates for previous transmissions of the transport block depends on delay requirements of the TB. For example, if delay requirements permit N transmissions and the upcoming i-th transmission is the last transmission the quality values obtained for the previous transmission is determined in a conservative way. For example, the SINR in dB-scale could be obtained as −∞ which would result in that the RBI contribution from the previous transmissions being zero.

In some examples, the gNB has frequency selective knowledge about quality. Such knowledge can be obtained from frequency-selective CQI reports or code block group (CBG) HARQ-ACK and/or that the UE reports an indicator that indicates a frequency-selective quality measure of reception of the PDSCH used to transmit the transport block. In such examples, quality measures may be frequency-selectively stored/obtained. For example, if UE reports frequency selective CQI, then quality statistics may be determined for each of the reported CSI sub-bands and predicted quality and the uncertainty may be determined from mean and std SINR for the sub-bands in which a PDSCH transmission was overlapping.

In another embodiment, after obtaining quality estimates the gNB may decide to use a Code Block Group Flush Indicator (CBGFI) in the next downlink control information (DCI) that schedules re-transmission. This decision can be based on one or more quality measures reported by UE. In one example, the gNB may decide to flush the soft buffer for one or more CBGs if accumulated received bits by the UE is below a defined threshold which can be an absolute value or a percentage of the number of transmitted bits. In such examples, the gNB flushes/resets its associated/corresponding storage of quality measures (e.g., the corresponding RBI contribution is set to be zero).

In some examples, the gNB needs to interrupt a transmission to the UE. The gNB would then transmit a PI (Pre-emption Indicator) to UE that indicates time-frequency location where pre-emption occurred to enable UE to flush its soft-buffer accordingly. When PI is sent to UE, the gNB also flush/resets associated/corresponding storage of quality measures (e.g., corresponding RBI contribution set to be zero).

In further other embodiments, the UE may report CBG HARQ-ACK, and the gNB may obtain quality measures based on CBG HARQ-ACK. If the number of incorrect CBGs is m and n_{CBG} CBGs were used for the corresponding PDSCH transmission, then the ratio m/n_{CBG} provides an estimate of the CBG error rate. In NR, interleaved VRB-to-PRB mapping can be used to average out the SINR difference for all CBGs such that CBG error probability is approximately the same for all CBGs. This may enable the gNB to determine the likely SINR that prevailed for the PDSCH transmission using the coding model. Furthermore, by assuming that number of CBGs that is incorrectly decoded by UE is a binomially distributed random variable X~Bi(p_{CBG}, n_{CBG}), the gNB can estimate how likely the ratio m/n_{CBG} is for an assumed SINR or CBG error probability. For a given CBG error probability p_{CBG}, the probability that at most m of the CBGs is incorrect equals:

$$Pr \{ X \leq m \} = {\sum }_{i = 0}^{m} ( \begin{matrix}{n}_{CBG} \\ i\end{matrix} ) {{p}_{CBG}^{l} ( 1 - {p}_{CBG} )}^{{n}_{CBG} - i} \qquad [ 4 ]$$

This enables the gNB to determine if the ratio m/n_{CBG} is likely to be observed for an assumed SINR to prevail for the PDSCH reception. For example, if the assumed SINR corresponds to p_{CBG}=3% and n_{CBG}=8, then m/n_{CBG}≤25% occurs with a probability ~99.9%. With 99.9% certainty, the gNB can then assume that the prevailed SINR was not lower than the assumed SINR if UE reports CBG HARQ-ACK with m=2.

The normal distribution assumption of the SINR is given as an example. A different SINR distribution, such as skew-normal distribution, may be assumed in some embodiment. Such assumption may require that more than mean and standard deviation is known/estimated, e.g. for skew-normal distribution the skewness is needed. Although calculations may be more complicated it is straightforward to apply the methods described herein.

For evaluating a potential modulation to be used to re-transmit the TB, at block 206, the obtained quality values for previous transmissions are mapped to RBI values. More precisely, when LA is performed at the i-th transmission RBI values rbiⱼ for transmissions j=0, . . . ,i−1 are determined from obtained quality values. For a tentative modulation, the number of coded bits nᵢ for the upcoming i-th transmission is determined based on the resource assignment intendent for the i-th transmission and the tentative modulation. The accumulated number of coded bits

$${n}_{tot} = {\sum }_{j = 0}^{j} {n}_{j}$$

where nⱼ, j=0, 1 . . . ,i−1, are the obtained number of coded bits for the previous transmissions. Next, a predicted received bit information rbi; to assume for the i-th transmission.

In some examples, rbiᵢ is determined from the latest CSI report.

In some examples, rbi is determined based on rbiⱼ, j=0, 1, . . . , i−1. For example,

$${rbi}_{i} = {n}_{i} {\sum }_{j = 0}^{i - 1} \frac{{rbi}_{j}}{{n}_{j}}$$

Another example could be to determine rbiᵢ from the mean SINR (SINR is the obtained quality values). Several other examples are possible, where min, max, median or other statistical measure are other examples how rbiᵢ could be obtained from the obtained quality values for previous transmissions. One such another example is

$${rbi}_{i} = {n}_{i} min \{ \frac{{rbi}_{j}}{{n}_{j}} : j = 0 , 1 , … , i - 1 \} .$$

In further other examples, the minimum could be among the rbiⱼ/nⱼ and the rbi_{cqi}/nᵢ where rbi_{cqi} is determined from latest CSI report.

In one example, the method to be conservative in the LA function for the least transmission within a latency bound is performed when determining rbiᵢ. If the i-th transmission is not the last transmission within the latency bound, then rbiᵢ could be determined from the latest CSI report, but if it is the last transmission then

$${rbi}_{i} = {n}_{i} min \{ \frac{{rbi}_{cqi}}{{n}_{i}} , \frac{{rbi}_{j}}{{n}_{j}} : j = 0 , 1 , … , i - 1 \} .$$

In some examples, the level of conservatism in the LA function depends on how many transmissions remain within the latency budget. For example,

$${rbi}_{min} = {n}_{i} min \{ \frac{{rbi}_{cqi}}{{n}_{i}} , \frac{{rbi}_{j}}{{n}_{j}} : j = 0 , 1 , … , i - 1 \} and$$

$${rbi}_{max} = {n}_{i} max \{ \frac{{rbi}_{cqi}}{{n}_{i}} , \frac{{rbi}_{j}}{{n}_{j}} : j = 0 , 1 , … , i - 1 \}$$

could be determined, and if N transmissions are possible within the latency budget, then rbiᵢ could be determined as:

$${rbi}_{i} = \frac{i - 1}{N - 1} {rbi}_{min} + \frac{N - i}{N - 1} {rbi}_{max} \qquad [ 5 ]$$

This would mean that rbiᵢ=rbiₘₐₓ if i=1, i.e. it is the first re-transmission, and rbiᵢ=rbiₘᵢₙ if i=N−1, i.e. it is the last (re-)transmission possible within the latency budget.

Once rbiᵢ has been determined, the effective RBIR can be determined as

$$rbir = \frac{{\sum }_{j = 0}^{i} {rbi}_{j}}{{n}_{tot}} .$$

From the transport block size and the number of coded bits n₀, . . . ,nᵢ, an initial code rate crᵢₙᵢₜᵢₐₗ and effective code rate cr_{effective} can be determined. From the coding model, the BLEP for the tentative modulation could be determined from the function blep(n_{info},crᵢₙᵢₜᵢₐₗ,cr_{effective},rbir), where n_{info} is the number of information bits corresponding to the transport block. If the BLEP for the modulation is below a target value, the modulation is determined at block 210 to be an acceptable candidate modulation.

In some variants of this embodiment, the BLEP for a tentative modulation is determined as a numerical integration over a probability density distribution of rbir. For example, the SINR for i-th transmission could be assumed to be normal distribution. Since a SINR value can be mapped to RBI value, the rbiᵢ would then be random variable that is a function of a normal distributed random variable. Consequently, rbir would also be a function of a normal distributed random variable. The BLEP could then be determined as the numerical integration:

BLEP=∫blep(n_{info};crᵢₙᵢₜᵢₐₗ,cr_{effective};rbir(x)p_{X}(x)dx [6]

where p_{X}(x) is the probability density function of the SINR and rbir(·) is the function that maps a SINR value for the upcoming transmission to an effective RBIR.

In some variants of this embodiment, the target value is a fixed value e.g. 10% while in other variants the target value is a function of i and the initial BLEP target. For example, BLEP_{target}(i)=BLEP_{target}(0)ⁱ.

In further other variants, the BLEP for the initial transmission is not limited to a threshold. In such variants, the BLEP for the initial transmission is a result of the LA decision targeting high throughput and/or high spectral efficiency. In such examples, the target BLEP (BLEP threshold) for the i-th transmission may be same as the expected BLEP for the initial transmission or a function of i and the BLEP for initial transmission. For example, if BLEP for the initial transmission equals BLEP(0), then BLEP target or threshold for i-th transmission may be determined as BLEP_{target}(i)=BLEP_{target}(0)^{α}, where α is a parameter. To exemplify, it may be assumes that BLEP_{target}(0)=0.5, which with α=1.0 would give BLEP_{target}(i)=0.5. 0.25 and 0.125 for i=1,2,3 while α=1.5 would give BLEP_{target}(i)≈0.354,0.125 and 0.044 for i=1,2,3.

In some variants, the UE may be configured with CBG HARQ-ACK wherein the gNB can re-transmit only the CBGs for which UE reports HARQ NACK (i.e., indication of in-correct decoding). In such example, the gNB may choose to have a BLEP target with respect to CBG instead of the transport block (TB). As above, the gNB may assume that the number of incorrectly decoded CBGs to be a random variable X~Bi(p_{CBG}, n_{CBG}), The relation between CBG error probability p_{CBG} and the TB error probability p_{TB} is then p_{TB}=1−(1−p_{CBG})^{(nCBG)}.

In another embodiment, the gNB may configure the UE to provide more extensive CSI reporting for single and for multiple transmission points (multi-TRP). The LA function in the gNB may decide to use single or multiple TRP to be able to regulate reliability of the transmission. In this case the obtaining steps of quality measures may depend if the transmission is a single-TRP or multi-TRP transmission. It is also possible to determine the rbi; when performing LA for the i-th transmission depending on if the i-th transmission is a single- or multi-TRP transmission.

At block 220, if the LA function finds more than one suitable modulation for the same resource allocation size, then it is preferred to select the modulation with fewer bits per symbol. If the LA function finds that there is no suitable modulation, then LA may indicate to the scheduler at block 218 that a larger resource allocation is needed.

In further embodiments, obtaining and determination of quality measures and mapping to RBI may further depend on the number of MIMO layers, MIMO user multiplexing, SU-MIMO or MU-MIMO, and/or whether the TB is co-transmitted with a second TB.

Figure QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of Figure QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

Figure QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3 rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

Figure QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

Figure QQ4 is a block diagram of a host QQ400, which may be an embodiment of the host QQ116 of Figure QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Figure QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQS04 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQS04 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Figure QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of Figure QQ1 and/or UE QQ200 of Figure QQ2), network node (such as network node QQ110a of Figure QQ1 and/or network node QQ300 of Figure QQ3), and host (such as host QQ116 of Figure QQ1 and/or host QQ400 of Figure QQ4) discussed in the preceding paragraphs will now be described with reference to Figure QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UB QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the likelihood of successful retransmission of transport blocks and thereby provide benefits such as reduced latency, reduced user waiting time, and/or reduced network resource utilization.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, re-transmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

A1. A method performed by a network node for performing link adaptation for a re-transmission of a transport block by the network node, the method comprising:
obtaining (202) an accumulated number of transmitted bits from previous unsuccessful transmissions of the transport block;
obtaining (204) quality measures for the previous unsuccessful transmissions of the transport block;
estimating (210) a block error probability, BLEP, for the re-transmission of the transport block based on using a proposed modulation for the re-transmission of the transport block;
determining (210) whether the estimated BLEP is less than a target probability; and
in response to determining that the estimated BLEP is less than the target probability, re-transmitting (222) the transport block using the proposed modulation.

A2. The method of Embodiment A1, wherein estimating the BLEP is based at least in part on a resource allocation for the re-transmission of the transport block.

A3. The method of any previous Embodiment, further comprising:
in response to determining that the estimated BLEP is less than the target probability:
selecting a second modulation;
estimating (210) the BLEP for the re-transmission of the transport block based using on the second modulation for the re-transmission of the transport block;
determining (210) whether the estimated BLEP is less than the target probability; and
in response to determining that the estimated BLEP is less than the target probability, re-transmitting (222) the transport block using the second modulation.

A4. The method of any previous Embodiment, further comprising:
in response to determining that the estimated BLEP is not less than the target probability for any candidate modulation, obtaining a larger resource allocation for the re-transmission of the transport block.

A5. The method of any previous Embodiment, further comprising:
repeating the operations for each modulation in a set of possible modulations:
selecting (208) a potential modulation from the set of possible modulations;
estimating (210) the BLEP for the re-transmission of the transport block based using on the selected modulation for the re-transmission of the transport block;
determining (210) whether the estimated BLEP is less than the target probability; and
in response to determining that the estimated BLEP is less than the target probability, adding (212) the potential modulation to a list of candidate modulations for re-transmitting the transport block.

A6. The method of Embodiment A5, further comprising:
selecting (220) a modulation from the list of candidate modulations; and
re-transmitting (222) the transport block using the modulation selected from the list of candidate modulations.

A7. The method of Embodiment A5, wherein a modulation in the list of candidate modulations having a lowest number of bits per symbol is selected as the modulation for re-transmitting the transport block.

A8. The method of any previous Embodiment, wherein obtaining (202) the accumulated number of transmitted bits from previous unsuccessful transmissions of the transport block comprises calculating the accumulated number of transmitted bits based on modulations used and a number of modulation symbols used in the previous unsuccessful transmissions.

A9. The method of any previous Embodiment, wherein the quality measures of the previous unsuccessful transmissions comprise a channel quality indicator, CQI, associated with at least one of the previous unsuccessful transmissions.

A10. The method of any previous Embodiment, wherein the quality measures of the previous unsuccessful transmissions comprise a hybrid automatic repeat request, HARQ, acknowledgment of at least one of the previous unsuccessful transmissions.

A11. The method of any previous Embodiment, wherein the quality measures of the previous unsuccessful transmissions comprise a fixed quality measurement that is selected based on a radio condition of a cell used for the previous unsuccessful transmissions.

A12. The method of any previous Embodiment, wherein the quality measures of the previous unsuccessful transmissions comprise a value that is determined relative to a value of channel quality that was predicted for at least one of the previous unsuccessful transmissions.

A13. The method of Embodiment A12, wherein the value of the channel quality that was predicted for at least one of the previous unsuccessful transmissions comprises a signal to interference plus noise ratio, SINR, that was predicted for the at least one of the previous unsuccessful transmissions, and wherein the value of the value of the quality measure for the at least one of the previous unsuccessful transmissions comprises the SINR less a fixed backoff, B,

A14. The method of any previous Embodiment, wherein the quality measures of the previous unsuccessful transmissions comprise a code block group, CBG, HARQ acknowledgement.

A15. The method of Embodiment A1, further comprising:
estimating (206) an effective received bit information rate, RBIR, for the previous unsuccessful transmissions and the re-transmission of the transport block, wherein the BLEP is estimated based on the effective RBIR for the previous unsuccessful transmissions and the re-transmission of the transport block.

A16. The method of Embodiment A15, wherein the effective RBIR is estimated according to the following formula:

$$rbir = \frac{{\sum }_{j = 0}^{i} {rbi}_{j}}{{n}_{tot}}$$

wherein rbiⱼ is a received block information, RBI, of a j-th trasmission of the transport block and nₜₒₜ is a total number of bits transmitted in the previous unsuccessful transmissions and the re-transmission of the transport block.

A17. The method of Embodiment A15 or A16, wherein estimating the BLEP for the retransmission of the transport block is performed based on a coding model having the form:

BLEP=∫blep(n_{info},crᵢₙᵢₜᵢₐₗ,cr_{effective},rbir(x))p_{X}(x)dx
wherein n_{info} is a number of information bits corresponding to the transport block, crᵢₙᵢₜᵢₐₗ is an initial code rate used to transmit the transport block, cr_{effective} is an effective code rate used to transmit the transport block, and pₓ(x) is a probability density function of a signal to interference plus noise ratio, SINR, of the previous transmissions of the transport block.

A18. A method performed by a network node for performing link adaptation for a re-transmission of a transport block by the network node, the method comprising:
obtaining (202) an accumulated number of transmitted bits from previous unsuccessful transmissions of the transport block;
obtaining (204) quality measures for the previous unsuccessful transmissions of the transport block;
for each modulation in a set of possible modulations:
   estimating (210) a block error probability, BLEP, for the re-transmission of the transport block based on using the modulation for the re-transmission of the transport block;
   determining (210) whether the estimated BLEP is less than a target probability; and
   in response to determining that the estimated BLEP is less than the target probability, adding the modulation to a list of candidate modulations;
selecting a modulation from the list of candidate modulations; and
re-transmitting (222) the transport block using the selected modulation.

A19. The method of any of the previous embodiments, further comprising:
obtaining user data; and
forwarding the user data to a host or a user equipment.

### Group B Embodiments

B1. A user equipment, comprising:
processing circuitry configured to perform any of the steps of any of the Group A embodiments; and
power supply circuitry configured to supply power to the processing circuitry.

B2. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group A embodiments to transmit the user data from the host to the UE.

B3. The host of the previous embodiment, wherein:
the processing circuitry of the host is configured to execute a host application that provides the user data; and
the UE comprises processing circuitry configured to execute a client application associated with the host application to receive the transmission of user data from the host.

B4. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group A embodiments to transmit the user data from the host to the UE.

B5. The method of the previous embodiment, further comprising, at the network node, transmitting the user data provided by the host for the UE.

B6. The method of any of the previous 2 embodiments, wherein the user data is provided at the host by executing a host application that interacts with a client application executing on the UE, the client application being associated with the host application.

B7. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group A embodiments to transmit the user data from the host to the UE.

B8. The communication system of the previous embodiment, further comprising:
the network node; and/or
the user equipment.

B9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group A embodiments to receive the user data from a user equipment (UE) for the host.

B10. The host of the previous embodiment, wherein:
the processing circuitry of the host is configured to execute a host application, thereby providing the user data; and
the host application is configured to interact with a client application executing on the UE, the client application being associated with the host application.

B11. The host of the any of the previous 2 embodiments, wherein the initiating receipt of the user data comprises requesting the user data.

B12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group A embodiments to receive the user data from the UE for the host.

B13. The method of the previous embodiment, further comprising at the network node, transmitting the received user data to the host.

1. A method by a network node for link adaptation for a re-transmission of a transport block, the method comprising:
obtaining an accumulated number of transmitted bits from previous transmission(s) of the transport block;
obtaining quality measures for the previous transmission(s) of the transport block;
estimating a block error probability, BLEP, for the re-transmission of the transport block based on using a selected modulation for the re-transmission of the transport block;
comparing the estimated BLEP with a target BLEP; and
in response to the estimated BLEP being less than the target BLEP, re-transmitting (222) the transport block using the selected modulation.

2. The method of claim 1, further comprising:
in response to the estimated BLEP being less than the target BLEP:
selecting a second modulation having a lower number of bits per symbol than the selected modulation used in the previous estimation;
estimating the BLEP for the re-transmission of the transport block based on using the second modulation for the re-transmission of the transport block;
comparing the estimated BLEP based on the second modulation is less than the target BLEP;
wherein the re-transmitting the transport block comprises:
in response to the estimated BLEP based on the second modulation being less than the target BLEP, selecting the second modulation for re-transmitting the transport block.

3. The method of claim 2, wherein the re-transmitting the transport block comprises:
in response to the estimated BLEP based on the second modulation being not less than the target BLEP, selecting the previous selected modulation with which the estimated BLEP is less than the target BLEP.

4. The method of claim 1, wherein estimating the BLEP is based at least in part on a resource allocation for the re-transmission of the transport block.

5. The method of claim 4, further comprising:
in response to none of the estimated BLEP(s) is less than the target BLEP, obtaining a larger resource allocation for the re-transmission of the transport block.

6. The method of claim 2, wherein:
selecting the second modulation from a set of possible modulations;
in response to determining that the estimated BLEP based on the second modulation is less than the target BLEP, adding the second modulation to a list of candidate modulations for re-transmitting the transport block.

7. (canceled)

8. The method of claim 1, wherein obtaining the accumulated number of transmitted bits from previous transmission(s) of the transport block comprises calculating the accumulated number of transmitted bits based on modulations used and a number of modulation symbols used in the previous transmission(s).

9. The method of claim 1, wherein the quality measures of the previous transmission(s) comprise a channel quality indicator, CQI, associated with at least one of previous unsuccessful transmissions.

10. The method of claim 1, wherein the quality measures of the previous transmission(s) comprise:
a hybrid automatic repeat request, HARQ, acknowledgment of at least one of previous unsuccessful transmissions; or a fixed quality measurement that is selected based on a radio condition of a cell used for previous unsuccessful transmissions.

11. (canceled)

12. The method of claim 1, wherein the quality measures of the previous transmissions comprise a value that is determined relative to a value of channel quality that was predicted for at least one of previous unsuccessful transmissions.

13. The method of claim 12, wherein the value of the channel quality that was predicted for at least one of the previous unsuccessful transmissions comprises a signal to interference plus noise ratio, SINR, that was predicted for the at least one of the previous unsuccessful transmissions, and wherein the value of the value of the quality measure for the at least one of the previous unsuccessful transmissions comprises the SINR less a fixed backoff, B.

14. The method of claim 1, wherein the quality measures of the previous transmission(s) comprise a code block group, CBG, HARQ acknowledgement.

15. The method of claim 1, further comprising: estimating an effective received bit information rate, RBIR, for the previous transmission(s) and the re-transmission of the transport block, wherein the BLEP is estimated based on the effective RBIR for the previous transmission(s) and the re-transmission of the transport block.

16. The method of claim 15, wherein the effective RBIR is estimated according to the following formula:
$$rbir = \frac{{\sum }_{j = 0}^{i} {rbi}_{j}}{{n}_{tot}}$$
wherein rbiⱼ is a received block information, RBI, of a j-th trasmission of the transport block and nₜₒₜ is a total number of bits transmitted in the previous unsuccessful transmissions and the re-transmission of the transport block.

17. The method of claim 15, wherein estimating the BLEP for the retransmission of the transport block is performed based on a coding model having the form:
BLEP=∫_{blep}(n_{info},crᵢₙᵢₜᵢₐₗ,cr_{effective},rbir(x))p_{X}(x)dx
wherein n_{info} is a number of information bits corresponding to the transport block, crᵢₙᵢₜᵢₐₗ is an initial code rate used to transmit the transport block, cr_{effective} is an effective code rate used to transmit the transport block, and pₓ(x) is a probability density function of a signal to interference plus noise ratio, SINR, of the previous transmissions of the transport block.

18. A network node configured to perform link adaptation for a re-transmission of a transport block, comprising:
a processing circuitry, a memory, the memory containing instructions executable by the processing circuitry whereby the network node is operative to perform the method according to claim 1.
